(19) United States
(12) Patent Application Publication
(10) Pub. No.: US 2019/0002664 A1
(43) Pub. Date: Jan. 3, 2019

(54) PROCESS FOR PRODUCING WAXES AND LIQUID FUELS FROM WASTE PLASTIC

(71) Applicant: SOLVAY SA, Brussels (BE)

(72) Inventors: Stéphane STREIFF, Shanghai (CN); Dominique BALTHASART, Brussels (BE); Marco PICCININI, Brussels (BE); Avelino CORMA, Valencia (ES); Miriam CERRO-ALARCÓN, Valencia (ES); Jesús MENGUAL, Carcaixent (ES)

(73) Assignee: SOLVAY SA, Brussels (BE)

(21) Appl. No.: 16/062,688

(22) PCT Filed: Dec. 15, 2016
(86) PCT No.: PCT/EP2016/081311

§ 371 Date: Jun. 15, 2018

(30) Foreign Application Priority Data
Dec. 18, 2015 (EP) 15201130.0

(51) Int. Cl. C08J 11/12; C10G 1/08; C10G 55/06

(52) U.S. Cl. CPC C08J 11/12; C10G 9/00; C10G 55/06; C10G 1/08

(57) ABSTRACT

The present invention relates to a process for producing waxes and liquid fuels from waste plastic.

This application claims priority to European application No. 15201130.0—filed on Dec. 18, 2015-, the whole content of this application being incorporated herein by reference for all purposes.

The present invention relates to a process for producing waxes and liquid fuels from waste plastic.

In view of the increasing importance of polymers as substitutes for conventional materials of construction such as glass, metal, paper, and wood, the perceived need to convert non-renewable resources such as petroleum and dwindling amounts of landfill capacity available for the disposal of waste products, considerable attention has been devoted in recent years to the problem of recovering, reclaiming, recycling or in some way reusing waste plastic.

It has been proposed to pyrolyze or catalytically crack the waste plastic so as to convert high molecular weight polymers into volatile compounds having a much lower molecular weight. The volatile compounds, depending on the process employed, can be either relatively high boiling liquid hydrocarbons useful as fuel oils or fuel oil supplements or light to medium boiling hydrocarbons useful as gasoline-type fuels or as other chemicals.

Mixed industrial or post-consumer plastics are available from sorting plants as mixed plastic objects of large size contaminated with a number of impurities. The chemical valorization or recycling of these mixed plastics typically needs a pretreatment step that, optionally including the reduction of the particle size to suitable ranges, comprises a step of separation of detrimental impurities, such as wood, paper, glass, undesired plastics, etc.

A process of converting a mixed waste plastic into a low molecular weight organic compound by catalytic cracking is described in US 2012/0215043. Before being contacted with a solid catalyst in a fluidized bed reactor, the waste plastic is pretreated by flotation, washing, drying and separation.

U.S. Pat. No. 5,569,801 also relates to a process for the conversion of polymers and particularly for the conversion of plastic containers or other plastic wastes. While any pretreatment is not specifically described, it is reported that during the further process hydrochloric acid vapor may be formed and that it is necessary to convey the hydrochloric acid into a neutralization system.

US 2003/0019789 relates to a method and system for the continuous preparation of gasoline, kerosene and diesel oil from waste plastics. The method comprises dehydrogenating and decomposing waste plastics, and then subjecting the resulting waste plastics to a fluid catalytic cracking. Prior to catalytic cracking, the waste plastics are melted and it is described that the obtained melt is dewatered by elevating the temperature to 150° C.

The known processes have the disadvantage that they either require dewatering or additional neutralization systems for removing undesired hydrochloric acid vapor. Hydrochloric acid vapor is undesired in the cracking reactor and also in other parts of the plant because of corrosion problems in particular in the presence of water.

The present inventors now surprisingly found that the above and other problems can be solved and the overall process can be improved if the pretreatment of the waste plastic is conducted as a dry pretreatment. This avoids an excessive amount of water in the further process thereby reducing the problems associated with the presence of water during processing and cracking.

The present invention therefore relates to a process for producing waxes and liquid fuels from waste plastic, the process comprising the steps of subjecting the waste plastic to a dry pretreatment, and subsequently subjecting the pretreated waste plastic to cracking.

In the context of the present invention, waxes are to be understood as a mixture of hydrocarbons optionally comprising heteroatoms, such as O, N, etc., being solid at room temperature (23° C.) and having a softening point of generally above 45° C. Liquid fuels are to be understood as combustible liquid hydrocarbons optionally comprising heteroatoms, such as O, N, etc., being liquid at room temperature, such as gasoline, kerosene and diesel oil.

The invention therefore allows producing valuable chemicals from waste plastic, such as post-consumer waste plastic, off spec plastic, industrial scrap plastic and the like. The waste plastic can be a single plastic or, preferably, a mixed waste plastic.

A plastic is mostly constituted of a particular polymer and the plastic is generally named by this particular polymer. Preferably, a plastic contains more than 25% by weight of its total weight of the particular polymer, preferably more than 40% by weight and more preferably more than 50% by weight. Other components in plastic are for example additives, such as fillers, reinforcers, processing aids, plasticizers, pigments, light stabilizers, lubricants, impact modifiers, antistatic agents, inks, antioxidants, etc. Generally, a plastic comprises more than one additive.

Plastics suitable in the process of the present invention are for example polyolefins and polystyrene, such as high density polyethylene, low density polyethylene, polypropylene and polystyrene. Mixed plastics mostly constituted of polyolefin and polystyrene are preferred. In this context “mostly constituted” is to be understood such that the concentration of the polyolefin and the polystyrene in the mixed plastic is above 50% by weight, more preferably above 75% by weight, each based on the total weight of the dry mixed plastic. The mixed plastic may be constituted of polyolefin and polystyrene. Preferably, the mixed plastic contains less than 99.5% by weight, more preferably less than 99% by weight of polyolefin and polystyrene, based on the total weight of the dry mixed plastic.

Other plastics, such as polyvinylchloride, polyvinylidene chloride, polyethylene terephthalate, polyurethane (PU), acrylonitrile-butadiene-styrene (ABS), nylon and fluorinated polymers are less desirable. If present in the waste plastic, they are preferably present in a minor amount of less than 50% by weight, preferably less than 30% by weight, more preferably less than 20% by weight, even more preferably less than 10% by weight of the total weight of the dry waste plastic. Preferably, the individual content of any less desirable plastic is less than 5% by weight, more preferably less than 2% by weight based on the total weight of the dry waste plastic.

Usually, waste plastic contains other non-desired components, namely foreign material, such as paper, glass, stone, metal, etc.

In the process of the present invention, the waste plastic is subjected to a pretreatment. The pretreatment includes for example size reduction and foreign material removal. In the prior art processes in particular foreign material removal is often conducted in the presence of or using water. The thus obtained pretreated waste plastic is rather wet and requires either time and energy consuming drying or results in potential problems during further processing, such as corrosion. The present inventors additionally found that also the heat balance and coke formation in the cracking reactor can be impaired by the presence of water which vaporizes thereby cooling the contents of the cracking reactor in addition to the endothermic cracking reaction. Thus, water entering the cracking reactor together with the waste plastic requires additional energy or may even lead to an ununiform cooling within the reactor which may result in undesired coke formation on the catalyst particles. This may result in an increase in temperature when burning the coke in the regenerator which in turn may have an adverse influence on the overall energy balance of the system. Therefore, an essential feature of the present invention is that the pretreatment of the waste plastic is conducted as dry pretreatment.

Dry pretreatment is to be understood as a pretreatment in the absence of additional water. In this context, “additional water” is to be understood as water being present in addition to the water or moisture in the waste plastic before pretreatment. Thus, as pretreatment the waste plastic is for example not washed with water or separated from foreign material by floatation in water or an aqueous liquid.

Furthermore, dry pretreatment in the context of the present invention excludes any liquefying (e.g. melting or dissolving) of the waste plastic. Any liquefying step can optionally be conducted in addition to the dry pretreatment for example after the dry pretreatment and prior to subjecting the waste plastic to cracking.

Suitable dry pretreatment steps are for example size reduction by grinding or shredding and foreign material removal by separation by cycloning, air or gas elutriation, sieving and magnetic separation.

For example, during pretreatment the size of the mixed plastic pieces can be reduced to a suitable value to be handled. Waste plastic is available as “volume particles” having significant length in three directions, as “surface particles” having significant length in two directions and a much lower thickness or “line particles” having one major length and two minor dimensions. Examples of “volume particles” are pieces of shoe soles, car bumpers, residual plastic pieces from extrusion, etc. Examples of “surface particles” are pieces of bottles, bags, etc. Examples of “line particles” are wires, filaments, etc. For the volume particles the size if to be understood as the two larger dimensions of the particles, for surface particles, the larger of the two larger dimensions and for line particles, the larger dimension. Preferably, the waste plastic particles after size reduction have a maximum size of less than 100 mm, preferably less than 50 mm. Typical minimum size is 0.05 mm, preferably 0.1 mm. Suitable apparatuses for size reduction are known in the art.

Usually, the waste plastic includes some free water. “Free water” is to be understood as non-chemically bonded water. Usually, the water content of waste plastic is less than 20% by weight, preferably less than 10% by weight, each based on the total weight of the waste plastic. Since the pretreatment in the process of the present invention is a dry pretreatment, the water content of the waste plastic before and after pretreatment can be the same or the dry pretreatment can even reduce the water content of the waste plastic. The above preferred water contents of the waste plastic are preferably the water contents of the pretreated waste plastic.

Usually, the waste plastic is used in bulk with air enclosed in the bulk plastic. The present inventors found that also the presence of air and in particular oxygen in the waste plastic can adversely affect the cracking process. In particular, the presence of oxygen can be dangerous due to the risk of uncontrolled temperature increase or even explosion in the crack reactor. Therefore, it is preferred that the process comprises the further step of reducing the content of air and/or oxygen in the waste plastic prior to subjecting it to cracking. The content of air and/or oxygen in the waste plastic can for example be reduced by mechanical compression, applying vacuum, diluting the air by an inert gas, purging the waste plastic with an inert gas, and/or contacting the waste plastic with an oxygen scavenger. Suitable inert gases are nitrogen, carbon dioxide or combustion gases, combustion gases being preferred.

Furthermore, when a pneumatic transportation is used, which is preferred, as a transportation gas a suitable inert gas may be used. Suitable inert gases are nitrogen, carbon dioxide or combustion gases, combustion gases being preferred.

Preferably, the content of air in the waste plastic prior to subjecting it to cracking is lower than 10 g/kg of dry waste plastic, preferably lower than 5 g/kg of dry waste plastic.

In a further embodiment, the cracking is conducted at an oxygen content in the cracking reactor which is lower than 10 vol. % of the gas phase in the reactor, preferably lower than 5 vol. % of the gas phase in the reactor. The amount of oxygen in the reactor can be reduced by reducing the amount of air and/or oxygen in the supplied waste plastic.

After pretreatment, the plastic waste can be introduced in the cracking reactor by any suitable means known in the art. In one embodiment, the waste plastic is in solid state. For introducing solid waste plastic into the cracking reactor suitable means are screw conveyer, belt conveyer, pneumatic transportation, bucket elevator and flexiscrew (transitube). Screw conveyer and pneumatic transportation are preferred. Pneumatic transportation is preferably made using the inert gas as defined above. Preferably, by pneumatic transportation using an inert gas the oxygen content of the atmosphere surrounding the particles is reduced.

Before reacting, the waste plastic can be liquefied. Liquefaction can be conducted by any known means. Suitable means are heating, dissolving with a suitable solvent or a combination of heating and dissolving. Heating can be direct heating, indirect heating or a combination of both. Suitable direct heatings are steaming, contact with hot gas, contact with hot liquid, and contact with hot solid. Suitable indirect heatings are heat transfer through a surface, mechanical friction, etc. Heat transfer through a surface is the preferred indirect heating method.

During heating the waste plastic, if desired, can be azeotropically further dried with a suitable liquid. Examples of suitable liquids are hydrocarbons and in particular hydrocarbon mixes. Particularly suitable is a hydrocarbon mix produced by the pyrolysis of the waste plastic. Preferably, the light fraction of the fuel produced by the pyrolysis can be used to azeotropically further dry the waste plastic.

The liquefied waste plastic is usually a viscous liquid. In certain embodiments it can be convenient to reduce the viscosity of the liquefied waste plastic by adding a suitable diluent. A suitable diluent is a hydrocarbon mix, such as a hydrocarbon cut. A hydrocarbon cut is a mixture of hydrocarbons of various molecular weight optionally comprising heteroatoms, such as O, N, etc. Hydrocarbon cuts of any origin are suitable. Preferred is a hydrocarbon cut from the pyrolysis of plastic. Gasoline, kerosene, diesel or wax cut from pyrolysis of plastic or mixtures thereof are particularly preferred. Even more suitable are gasoline or wax cut from catalytic pyrolysis of mixed waste plastic. Gasoline cut is to be understood as a mixture mostly constituted of hydrocarbons having an atmospheric boiling point in the range of from 25 to 250° C., preferably of from 40 to 250° C., more preferably of from 50 to 150° C. Kerosene cut is to be understood as a mixture mostly constituted of hydrocarbons having an atmospheric boiling point in the range of from 100 to 350° C., preferably of from 150 to 250° C. Diesel cut is to be understood as a mixture mostly constituted of hydrocarbons having an atmospheric boiling point in the range of from 250 to 500° C., preferably of from 250 to 350° C. Wax cut is to be understood as a mixture mostly constituted of hydrocarbons having an atmospheric boiling point over 300° C., preferably over 350° C. In this context, “mostly constituted” means that the cut is constituted of at least 95% by weight of said hydrocarbons, preferably by more than 99% by weight of said hydrocarbons.

Hydrocarbon cut is an organic phase which may contain water either dissolved, separated and/or in the form of an emulsion. The water content is preferably less than 5% by weight, more preferably less than 2% by weight. Particularly suitable is a hydrocarbon mix produced by the pyrolysis of waste plastic, in particular mixed waste plastic. During the melting of the waste plastic some decomposition may occur. For example, small molecules may be released during the polymer decomposition. Such small molecules often contain heteroatoms. Heteroatoms are atoms other than hydrogen and carbon. Examples of heteroatoms are O, Cl, Br, F, S and N. Addition of a scavenger for the heteroatoms can be useful to avoid corrosion induced by such heteroatoms and/or avoid fuel contamination. Examples of scavengers for heteroatoms are minerals, such as lime, soda lime, magnesia, silico alumina, alumina, silica.

During the liquefaction of the waste plastic some solid may remain. Such solid may be material having a melting temperature higher than the set temperature, may result from the decomposition of the plastic material or the foreign material, or may be a reaction product of an additive with the above heteroatoms. Examples of solid material are char resulting from the decomposition of paper or thermoplastics, such as ABS or PU, or foreign material, such as glass and metal. These solids are conveniently removed by filtration of the melted plastic. Any filtration apparatus may be used, such as plan filters, cartridge filters, etc. Magnetic separation can also be used.

Subsequently, the pretreated waste plastic is subjected to cracking. Cracking can be thermal or catalytic cracking. Catalytic cracking is preferred.

In the cracking reactor, the pretreated waste plastic is contacted with a hot catalyst in a reaction chamber in order to pyrolyse the plastic material. The hot catalyst provides at least part of the energy required to bring the plastic material to the reaction temperature, to supply the heat required for the endothermic cracking reaction and to bring the reaction products in their state after reaction. Preferably, the hot catalyst provides at least 60%, more preferably at least 90% of the heat required. Adiabatic operation is particularly preferred. Optionally, a heat exchanger can be introduced in the reaction chamber in order to remove any excess heat. Preferably, no more than 10% of the heat is removed. Preferably, the heat is removed by overheating low pressure steam. Low pressure steam is a steam pressure between 1 bar absolute and 10 bar absolute, preferably between 1.5 bar absolute and 4 bar absolute, more preferably between 2 bar absolute and 3 bar absolute.

The pressure in the reaction chamber is usually between 50 kPa absolute and 1500 kPa absolute, preferably between 80 kPa absolute and 1000 kPa absolute, more preferably between 100 kPa absolute and 500 kPa absolute. A pressure above atmospheric pressure is most preferred.

The hot catalyst is introduced into the reaction chamber in the form of heated particles or a mixture of heated particles which may comprise inert particles. These particles including inert particles are designated as “hot solid”. Usually, the weight amount of hot solid is between 0.2 and 20 times the weight amount of plastic material, preferably between 0.5 and 10 times, more preferably between 1 and 12 times. Particularly preferred the amount of hot solid is between 3 and 9 times the amount of plastic material in the reaction chamber.

The residence time of the solid in the chamber may be between 0.1 and 6000 seconds, preferably between 1 and 3600 seconds, more preferably between 3 and 1800 seconds.

In one embodiment the temperature of the hot solid introduced in the reaction chamber is higher than the temperature in the reaction chamber. Usually, the temperature of the hot solid when introduced into the reaction chamber is between 100 and 500° C. above the temperature in the reaction chamber, preferably between 150 and 400° C. The temperature of the plastic material introduced into the reaction chamber is lower than the temperature in the reaction chamber. Usually, the temperature of the plastic material introduced into the reaction chamber is between 100 and 350° C. lower than the temperature in the reaction chamber, preferably between 150 to 300° C. lower.

The reaction chamber ensures the contact between the plastic feed and the hot solid and allows extracting a gaseous stream and a condensed stream. “Condensed stream” is to be understood as solid or liquid. Preferably, the condensed stream is a mixture of solid and liquid.

The reaction chamber can be any type known by the skilled person. Preferably, the reaction chamber has a continuous gas phase. The reaction chamber may be constituted of one or several zones having specific flow. Examples of reaction chambers and reaction zones are fluidized bed, bubbling, bed, spouted bed, entrained bed, etc. Fluidized bed and entrained bed are preferred. Fluidized bed is particularly preferred.

A fluidized bed can be operated using a gas flow from the bottom to the top in a riser or from the top to the bottom in a downer, a downer being preferred.

The reaction chamber can also include a condensed phase-gas separation zone. Examples of condensed phase-gas separation zones are decantation zone, sedimentation zone, elutration zone, filtration zone and cyclone. Preferably, the reaction chamber is made of at least two combined zones, more preferably, at least three combined zones, even more preferable at least four combined zones. One of these zones should be the reaction zone.

In a preferred embodiment, the reaction chamber is constituted of a downer, a decantation zone, a sedimentation zone and a cyclone zone.

Optionally, an auxiliary gas may be introduced into the reaction chamber. The auxiliary gas may be introduced in any zone, in particular in the reaction zone. Examples of auxiliary gases are steam, inert gas and recycled gases. Recycled gases are preferred. More preferably, recycled gases are mainly constituted of hydrocarbon gases having less than 6 carbon atoms, hydrogen, nitrogen, carbon oxide, steam, oxygen and/or noble gas. Preferably, recycled gas contains mainly hydrocarbon gases having less than 6 carbon atoms, hydrogen and nitrogen. Also preferred, the recycled gas contains less than 5 vol. % of oxygen, more preferably less than 2 vol. %. Recycling gases obtained after condensation of the gas stream extracted from the reaction chamber are particularly preferred. Optionally, a gas stream exiting from a regeneration chamber may be used as auxiliary gas introduced into the reaction chamber. Optionally, the auxiliary gas may be preheated. Preferably, the auxiliary gas is heated up to the temperature at the bottom of the reactor. Preferably, the preheating is conducted using the gases from the regenerator. Preferably, the gas leaving the regenerator. In a preferred embodiment, a gas-gas heater using the gas leaving the regenerator to preheat the auxiliary gas is used. Preferably, the auxiliary gas is introduced at the bottom of the decantation zone so as to flash the condensed phase from the residual gas.

A gaseous stream is extracted from the reaction chamber by any means known in the art. Preferably, the gaseous stream is extracted in a condensed phase-gas separation zone of the reaction chamber, preferably from a cyclone zone.

The gaseous flow leaving the reaction chamber is directed to a condenser where the heavier hydrocarbons are condensed. The condensation can be induced by any means, for instance indirect cooling in a heat exchanger, aerocondenser, or by direct contact with a quench. Direct contact is preferred. Condensation can be made in one or in several steps in series. Condensation in one or two steps in series is preferred. Condensation made by direct contact of the gaseous stream with a subcooled liquid is preferred. Particularly in two steps. The first condensation step can be conducted at a temperature sufficient to avoid the solidification of the condensed stream. As the molecular weight of the hydrocarbons produced by the cracking is dispersed, the use of a direct contact condensation with the circulation of a suitable hydrocarbon cut is preferred. Suitable hydrocarbon cuts are kerosene, diesel, mix of kerosene and diesel and the like. The contact can be conducted by any means known in the art. Examples of quench means are quench tee, venturi, vessel and column. Quench tee, vessel and venturi are preferred. A combination of quench tee and vessel is particularly preferred.

The liquid vapor mixture obtained in the quench may be separated by any means known in the art. Such means are gravity liquid vapor separator, cyclone, demister, filter, etc. Gravity separator and cyclone being preferred. A combination of a gravity separator and a cyclone is particularly preferred. Optionally, a fractionating column where final cooling and condensation of liquid pyrolysis products take place, may be employed.

The uncondensed gas may be used as a fluidizing or transporting gas or may be burnt in a combustor.

Optionally, a stripping of the liquid solid mixture extracted at the bottom of the reaction chamber is conducted in a fluidized bed or in an entrained bed by contacting the product with a suitable gas stream, preferably using an entrained bed. Suitable gas streams are overheated steam, inert gas, recycled gases from the production, recycled gases from the regeneration, etc. Overheated steam is preferred.

The stripped hydrocarbon and the gas are separated in a cyclone from the entrained particles and they are supplied through a transfer line to a quench where the waxes are condensed and separated. The stripped solid enters in a transporting line and it is transported to the regenerator, where coke and unconverted plastic material are burnt, for example in a fluidized bed.

In a preferred embodiment the solid comprising the catalyst is circulated between the cracking reactor and the regenerator. Most preferably, the temperature and flow of the circulating catalyst are adjusted to obtain a pre-selected temperature in the cracking reactor.

The temperature obtained in the reactor in case of adiabatic operation is the result of balance between the hot catalyst (flow and temperature) and the cold fluxes (plastic mix heating, cracking and vaporization of the products). The overall cracking reaction is endothermic and its extend results from the kinetic mainly influence by the catalyst nature, catalyst amount (catalyst/plastic ratio) and the temperature. The catalyst nature influence the selectivity and activity of the cracking (in term of gaseous, gasoline, diesel, kerosene, wax and coke and unconverted plastic fractions) the catalyst amount and the temperature. For example the plastic mix is introduced at a defined temperature and flow in a reaction chamber operating adiabatically. A hot catalyst stream is introduced in the reaction chamber at a relative flow rate versus the plastic mix in such a way to obtain the fixed temperature. The catalyst, the coke and the unconverted material are sent to a regenerator where air is introduced and the coke and unconverted material are burnt rising the temperature of the catalyst.

The temperature in the regenerator usually is from 600 to 1000° C., preferably from 650 to 800° C. The pressure in the regenerator may slightly exceed the pressure in the reaction chamber. Flue gas is separated from particles entrained from the fluidized bed in a cyclone.

The catalyst usually contains at least a FCC (fluid catalytic cracking) catalyst. Preferred are equilibrated FCC catalysts. Other catalysts such as SiO₂, SiO₂ Al₂O₃, zeolite, etc. may be added to modulate the cracking activity and adjust the waxes to fuel ratio. The hot catalyst recovered at the regenerator is preferably recycled to the reaction chamber.

The catalyst recovered as the regenerator may include unburnt material. Unburnt material includes the mineral impurities introduced with the plastic material. It also includes the products of the reaction of those impurities with the impurities produced by the cracking reaction or in the regeneration reaction. Examples of impurities produced by the cracking reaction are HCl, HBr, HF, SO₂, H₂S, CO₂, etc. Preferably, the mineral impurities are in the form of condensed matter, such as liquid or solid. More preferably, they are solid of low dimension. By low dimension one means less than 50 micron, preferably less than 20 micron. Fine particles obtained by abrasion of the catalyst are included in those mineral impurities. The gases leaving the regenerator are sent to a device allowing the separation of the condensed phase matter. Examples of such a device are cyclone, filter, electrostatic precipitator, quench vessel, etc. A cyclone is preferred. The condensed phase separated includes the ashes introduced with the plastic material, the reaction products formed in the reactor or in the regenerator, and the fine from the catalyst.

A more complete appreciation of the invention and many of the attendant advantages thereof will be readily understood by reference to the following detailed description when considered in connection with the accompanying drawings wherein:

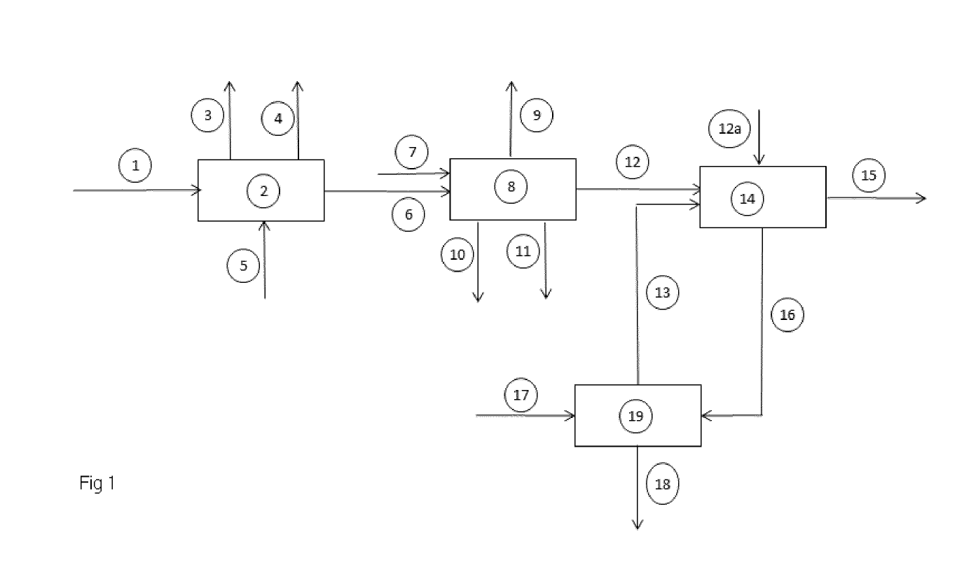

FIG. 1 shows a first embodiment of the process of the present invention and

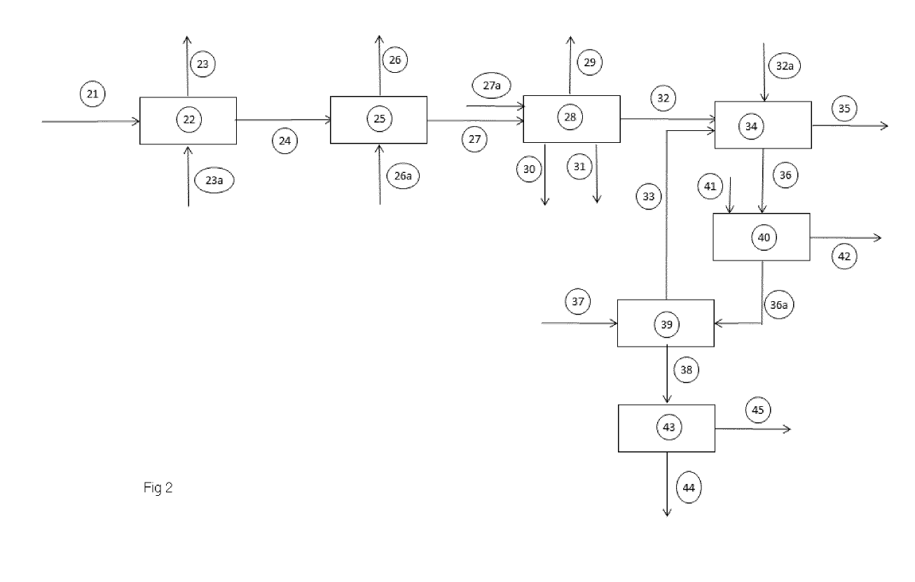

FIG. 2 shows another embodiment of the process of the present invention.

According to FIG. 1, the mixed plastic feed 1 is introduced in the pretreatment 2 where the plastic pieces are shrunked, part of the foreign material 3 is removed by elutriation and optionally at least part of the free water 4 is removed. Air 5 is optionally used for these operations. The mixed product leaving the pretreatment 6 is introduced in the melting device 8. An auxiliary liquid 7 is added. The product is liquefied by heating to a predefined temperature. The gases produced by the increase of temperature and/or by the decomposition of some components of the plastic and/or by the reaction of decomposition products are vented by 9. The air introduced with the mixed plastic feed is also vented. The foreign impurities not soluble are separated by decantation and optionally filtration giving low density 10 and high density 11 impurities. The liquefied product 12 is sent to the reaction chamber 14 with the hot catalyst 13 coming from the regenerator. An auxiliary gas 12a is introduced in the reaction chamber in order to purge the condensed matter flux 16 produced in the reaction chamber. The vapor flux 15 is sent to the condensation area not shown in the present figure. The condensed matter flux 16 is sent to the regenerator 19 where air 17 is injected. The regeneration increases the temperature of the catalyst 13 which is recycled to the reaction chamber. The gases produced by the reaction and the ashes 18 are extracted and sent to the effluent gas treatment not shown in the figure.

In a second embodiment the process is operated as in FIG. 2. The mixed plastic feed 21 is introduced in the pretreatment 22 where the plastic pieces are shrunked, part of the foreign material 23 are removed by elutriation using air 23a. The shrunked mixed plastic flow 24 is introduced in the dryer 25 where at least part of the free water 26 is removed. Air 26a is optionally used for these operations. The mixed product leaving the pretreatment 27 is introduced in the melting device 28. An auxiliary liquid 27a is added. The product is liquefied by heating to a predefined temperature. The gases produced by the increase of temperature and/or by the decomposition of some components of the plastic and/or by the reaction of decomposition products are vented by 29. The air introduced with the mixed plastic feed is also vented. The foreign impurities not soluble are separated by decantation and optionally filtration giving low density 30 and high density 31 impurities. The liquefied product 32 is sent to the reaction chamber 34 with the hot catalyst 33 coming from the regenerator. And auxiliary gas 32a is introduced in the reaction chamber in order to purge the condensed matter flux 36 produced in the reaction chamber. The vapor flux 35 is sent to the condensation area not shown in the present figure. The condensed matter flux 36 is sent to the stripping device 40 where a stripping gas 41 is introduced. The gas 42 extracted from the stripping device entraining the waxes is sent to a recovery unit not shown in the figure. The stripped solid 36a is sent to the regenerator 39 where air 37 is injected. The regeneration increases the temperature of the catalyst 33 which is recycled to the reaction chamber. The gases produced by the reaction and the ashes 38 are extracted and sent to the cyclone 43 where the solids 45 are separated from the gaseous effluent 44 that is sent to effluent gas treatment not shown in the figure.

Should the disclosure of any patents, patent applications, and publications which are incorporated herein by reference conflict with the description of the present application to the extent that it may render a term unclear, the present description shall take precedence.

### EXAMPLE 1 (ACCORDING THE INVENTION)

TABLE 1
Mix plastic stream compositions

| | 100 kg/h | 101 kg/h |
|---|---|---|
| PE | 698 | 698 |
| PP | 174 | 174 |
| PS | 4 | 4 |
| PVC | 1 | 1 |
| Water | 100 | |
| Organic impurities | 2 | 2 |
| Foreign solids | 18 | |
| Air | 3 | |
| Total | 1000 | 879 |

1000 kg of mixed waste plastic stream 100 having the composition of table 1 are introduced in the pretreatment section of a waste plastic pyrolysis equipment. The treatment shrinks the mixed waste plastic steam to pieces having a maximum dimension of 5 cm and removes the foreign solids, the air and the free water by elevating the temperature to 100° C. The waste plastic stream 101 leaving the pretreatment has the composition specified in table 1. It is introduced in a pyrolysis reactor operating at 425° C. In the pyrolysis reactor, 90% weight of the mixed waste plastic stream 101 are converted to gaseous products. The average specific heat of the plastics (PE+PP+PS+PVC) and of the organic impurities present in the pretreated mixed waste plastic stream 101 is estimated to 2.213 kJ/(dry kg)·K and to 1.5 kJ/kg·K respectively. The heat of reaction at 425° C. is evaluated to 798 kJ/kg (endothermic) and the heat of melting of the pretreated mixed plastic waste 101 is estimated to 200 kJ/kg. The heat duty of the reactor, calculated in the table 2, reaches 1437 MJ.

TABLE 2
Heat duty of the reactor for example 1 according to the invention

| | |
|---|---|
| Heating to reaction temperature, MJ | 632 |
| Melting, MJ | 175 |
| Reaction, MJ | 630 |
| Heat duty, MJ | 1437 |

### EXAMPLE 2 (FOR COMPARISON PURPOSES)

1000 kg of mixed waste plastic stream 100 having the composition of table 1 are introduced without pretreatment in a pyrolysis reactor operating at 425° C. The average specific heat of the plastics (PE+PP+PS+PVC) on one hand and of the organic impurities and foreign solids present in the mixed waste plastic stream 100 is estimated to 2.213 kJ/(dry kg)·K and to 1.5 kJ/kg·K respectively. The heat of reaction at 425° C. is evaluated to 798 kJ/kg (endothermic) at a conversion of 90% weight of the mixed plastic and the heat of melting of the mixed plastic is estimated to 200 kJ/kg. The water introduced with the plastic is vaporized in the reactor and joins the gaseous products. The air is heated up in the reactor and joins the gaseous products. The heat duty of the reactor, calculated in the table 3, reaches 1895 MJ.

TABLE 3
Heat duty of the reactor for comparative example 2

| | |
|---|---|
| Heating to reaction temperature, MJ | 1089 |
| Melting, MJ | 175 |
| Reaction, MJ | 630 |
| Heat duty, MJ | 1895 |

The comparison between table 2 and table 3 reveals that when the mix plastic stream is engaged in the reactor without beforehand dry pretreatment, or with a pretreatment involving presence of water, the heating required to reach reaction temperature is increased and, consequently, the heat duty of the reactor is also increased.

1. A process for producing waxes and liquid fuels from waste plastic, the process comprising the steps of
subjecting the waste plastic to a dry pretreatment, and
subsequently subjecting the pretreated waste plastic to cracking.

2. The process according to claim 1 wherein the dry pretreatment step comprises size reduction and/or foreign material removal.

3. The process according to claim 2 wherein the size reduction is accomplished by grinding or shredding and the foreign material removal is accomplished by separation by cycloning, air elutration, sieving and/or magnetic separation.

4. The process according to claim 1 wherein the pretreated waste plastic has a water content of less than 20% by weight based on the total weight of the waste plastic.

5. The process according to claim 1, further comprising the step of reducing the content of air and/or oxygen in the waste plastic prior to subjecting it to cracking.

6. The process according to claim 5 wherein the content of air and/or oxygen in the waste plastic is reduced by mechanical compression, applying vacuum, diluting the air by an inert gas, purging the waste plastic with an inert gas and/or contacting the waste plastic with an oxygen scavenger.

7. The process according to claim 1 wherein the content of air in the waste plastic prior to subjecting it to cracking is lower than 10 g/kg of dry waste plastic.

8. The process according to claim 1 further comprising the step of liquefying the waste plastic prior to subjecting it to cracking.

9. The process according to claim 1 wherein the cracking is thermal or catalytic cracking.

10. The process according to claim 1 wherein the cracking is catalytic cracking and the catalyst is circulated between a cracking reactor and a regenerator where coke deposit and optionally other combustible material is burnt.

11. The process according to claim 10 wherein temperature and/or flow of the circulating catalyst are adjusted to obtain a pre-selected temperature in the cracking reactor.

12. The process according to claim 1 wherein the cracking is catalytic cracking and the oxygen content in the cracking reactor is lower than 10 vol. % of the gas phase in the reactor.

13. The process according to claim 1 wherein the waste plastic is mixed waste plastic.

14. The process according to claim 13 wherein the mixed waste plastic comprises more than 50% by weight of polyolefin and polystyrene based on the total weight of the mixed waste plastic.

15. The process according to claim 1, which wherein the process is conducted continuously.

16. The process according to claim 4 wherein the pretreated waste plastic has a water content of less than 10% by weight, based on the total weight of the waste plastic.

17. The process according to claim 7 wherein the content of air in the waste plastic prior to subjecting it to cracking is lower than 5 g/kg of dry waste plastic.

18. The process according to claim 12 wherein the cracking is catalytic cracking and the oxygen content in the cracking reactor is lower than 5 vol. % of the gas phase in the reactor.
